(19) United States
(12) Patent Application Publication
(10) Pub. No.: US 2012/0246259 A1
(43) Pub. Date: Sep. 27, 2012

(54) EXCHANGING STREAMING INFORMATION

(75) Inventor: Wouter Anne Van Der Beek, Eindhoven (NL)

(73) Assignee: KONINKLIJKE PHILIPS ELECTRONICS N.V., EINDHOVEN (NL)

(21) Appl. No.: 13/512,934

(22) PCT Filed: Dec. 15, 2010
(86) PCT No.: PCT/IB10/55831

§ 371 Date: May 31, 2012

(30) Foreign Application Priority Data
Dec. 18, 2009 (EP) 09179851.2

(51) Int. Cl. G06F 15/167

(52) U.S. Cl. 709/213

(57) ABSTRACT

Intermediate devices (1) such as server devices receive streaming information (2) from source devices (3) and transmit the streaming information (4) possibly in a time-shifted manner via networks (5) to destination devices (6) such as client devices in client-server-combinations. To offer the time-shifted manner, the intermediate devices (1) comprise circular buffers (16) for storing at least parts of the streaming information (2, 4). By providing the intermediate devices (1) with transmitters (17) for transmitting buffer data (7) to the destination devices (6) and with receivers (18) for receiving request data (8) from the destination devices (6), for example in accordance with a network protocol, with the request data (8) defining sizes of time-shifts expressed at the hand of the buffer data (7), the circular buffers (16) can be used more flexibly by one destination device (6) and can be used by more than one destination device (6) in a relatively flexible environment. The intermediate/destination devices (1, 6) may be universal-plug-and-play-devices and/or digital-living-network-alliance-devices and/or open-internet-protocol-television-forum-devices and/or hybrid-broadcast-broadband-television-devices.

### FIELD OF THE INVENTION

The invention relates to an intermediate device for receiving streaming information from a source device and for transmitting the streaming information possibly in a time-shifted manner via a network to a destination device. The invention further relates to a destination device, to a system and to a method.

Examples of such an intermediate device are server devices. Examples of such a destination device are client devices.

### BACKGROUND OF THE INVENTION

U.S. Pat. No. 6,748,481 B1 discloses a streaming information appliance with a circular buffer for receiving and selectively reading blocks of streaming information. This is a relatively inflexible environment.

### SUMMARY OF THE INVENTION

Objects of the invention are to provide an intermediate device for receiving streaming information from a source device and for transmitting the streaming information possibly in a time-shifted manner via a network to a destination device, and to provide a destination device, a system and a method for a relatively flexible environment.

According to a first aspect of the invention, an intermediate device is provided for receiving streaming information from a source device and for transmitting the streaming information possibly in a time-shifted manner via a network to a destination device, the intermediate device comprising:

a circular buffer for storing at least a part of the streaming information and for offering the time-shifted manner,

a transmitter for transmitting buffer data to the destination device, and

a receiver for receiving request data from the destination device, the request data defining a size of a time-shift expressed at the hand of the buffer data.

Usually, a circular buffer is used for storing at least a part of the streaming information and for offering the time-shifted manner. By having added a transmitter to the intermediate device for transmitting buffer data to the destination device, the destination device can get data about the circular buffer, such as for example data that specifies how the circular buffer is used and/or what part of the circular buffer is used. By having added a receiver to the intermediate device for receiving request data from the destination device, which request data defines a size of a time-shift expressed at the hand of the buffer data, the destination device can express a time-shift at the hand of the buffer data, such as for example a time-shift in terms of the buffer data and/or a time-shift as a function of the buffer data, and can send the request data with this time-shift to the intermediate device. As a result, the circular buffer can be used more flexibly by one destination device, and more than one destination device could use the same circular buffer. This is a relatively flexible environment.

According to an embodiment, the intermediate device is defined by the destination device being at least a part of a client device and the intermediate device being at least a part of a server device in a client-server-combination. Especially for client-server-combinations, it is advantageous to offer a relatively flexible environment.

According to an embodiment, the intermediate device is defined by the intermediate device and the destination device being at least parts of universal-plug-and-play-devices and/or of digital-living-network-alliance-devices and/or of open-internet-protocol-television-forum-devices and/or of hybrid-broadcast-broadband-television-devices. Especially for universal-plug-and-play-devices and/or digital-living-network-alliance-devices and/or open-internet-protocol-television-forum-devices and/or hybrid-broadcast-broadband-television-devices, it is advantageous to offer a relatively flexible environment.

According to an embodiment, the intermediate device is defined by the buffer data and the request data being in accordance with a network protocol of the network. The network allows the circular buffer to be used more flexibly by one destination device, and allows more than one destination device to use the same circular buffer.

According to an embodiment, the intermediate device is defined by the network protocol being a hypertext transfer protocol or a real time protocol or a wireless network protocol. Especially a hypertext transfer protocol and/or a real time protocol and/or a wireless network protocol are being used advantageously in a relatively flexible environment.

According to an embodiment, the intermediate device is defined by the buffer data defining a start position of the streaming information in the circular buffer and/or an end position of the streaming information in the circular buffer and/or a filling degree of the circular buffer and/or an expected filling degree of the circular buffer and/or a bit rate of a stream filling the circular buffer.

According to a second aspect of the invention, a destination device is provided for receiving streaming information possibly in a time-shifted manner via a network from an intermediate device that comprises a circular buffer for storing at least a part of the streaming information originating from a source device and for offering the time-shifted manner, the destination device comprising:

a further receiver for receiving buffer data from the intermediate device, and

a transmitter for transmitting request data to the intermediate device, the request data defining a size of a time-shift expressed at the hand of the buffer data.

According to an embodiment, the destination device is defined by the destination device being at least a part of a client device and the intermediate device being at least a part of a server device in a client-server-combination.

According to an embodiment, the destination device is defined by the intermediate device and the destination device being at least parts of universal-plug-and-play-devices and/or of digital-living-network-alliance-devices and/or of open-internet-protocol-television-forum-devices and/or of hybrid-broadcast-broadband-television-devices.

According to an embodiment, the destination device is defined by the buffer data and the request data being in accordance with a network protocol of the network.

According to an embodiment, the destination device is defined by the network protocol being a hypertext transfer protocol or a real time protocol or a wireless network protocol.

According to a third aspect of the invention, a system is provided for exchanging streaming information, the system comprising the intermediate device as defined above and further comprising the source device and/or the network, or the system comprising the destination device as defined above and further comprising the network.

According to a fourth aspect of the invention, a method is provided for receiving streaming information from a source device and for transmitting the streaming information possibly in a time-shifted manner via a network to a destination device, the method comprising:

via a circular buffer, storing at least a part of the streaming information and offering the time-shifted manner,

via a transmitter, transmitting buffer data to the destination device, and

via a receiver, receiving request data from the destination device, the request data defining a size of a time-shift expressed at the hand of the buffer data.

The invention is based on an insight that an environment for exchanging streaming information via an intermediate device comprising a circular buffer should become relatively flexible. The invention is based on a basic idea that buffer data is to be transmitted from the intermediate device to a destination device and that request data is to be transmitted from the destination device to the intermediate device, which request data defines a size of a time-shift expressed at the hand of the buffer data.

The invention has solved a problem to provide an intermediate device for receiving streaming information from a source device and for transmitting the streaming information possibly in a time-shifted manner via a network to a destination device, and to provide a destination device, a system and a method for a relatively flexible environment. The invention is further advantageous in that the circular buffer can be used more flexibly by one destination device, and more than one destination device could use the same circular buffer.

These and other aspects of the invention are apparent from and will be elucidated with reference to the embodiment(s) described hereinafter.

### BRIEF DESCRIPTION OF THE DRAWINGS

In the drawings:

FIG. 1 shows a source device, an intermediate device and a destination device, a network being present between the intermediate device and the destination device,

FIG. 2 shows a source device, an intermediate device and a destination device, a network being present between the source device and the destination device, the intermediate device forming part of the network,

FIG. 3 shows an intermediate device and a destination device in greater detail,

FIG. 4 shows a representation of a circular buffer from a server's view, and

FIG. 5 shows a representation of a circular buffer from a client's view.

### DETAILED DESCRIPTION OF EMBODIMENTS

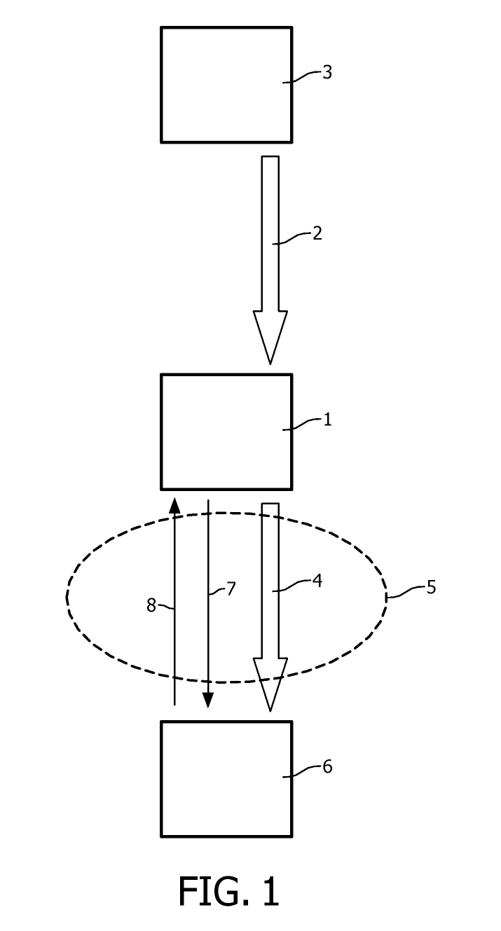

In the FIG. 1, a source device 3, an intermediate device 1 and a destination device 6 are shown, with a network 5 being present between the intermediate device 1 and the destination device 6. The source device 3 transmits streaming information 2 such as an audio/video file to the intermediate device 1. The intermediate device 1 transmits the streaming information 4 possibly in a time-shifted manner via the network 5 to the destination device 6. The intermediate device 1 stores at least a part of the streaming information 2, 4 and offers the time-shifted manner and transmits buffer data 7 via the network 5 to the destination device 6 and receives request data 8 via the network 5 from the destination device 6. This request data 8 defines a size of a time-shift to be introduced into the streaming information 2, 4. This time-shift is expressed at the hand of the buffer data 7.

The destination device 6 is for example at least a part of a client device and the intermediate device 1 is for example at least a part of a server device in a client-server-combination. Alternatively and/or in addition, the intermediate device 1 and the destination device 6 are for example at least parts of universal-plug-and-play-devices and/or of digital-living-network-alliance-devices and/or of open-internet-protocol-television-forum-devices and/or of hybrid-broadcast-broadband-television-devices.

The buffer data 7 and the request data 8 are for example in accordance with a network protocol of the network 5. This network protocol may be a hypertext transfer protocol or a real time protocol or a wireless network protocol etc.

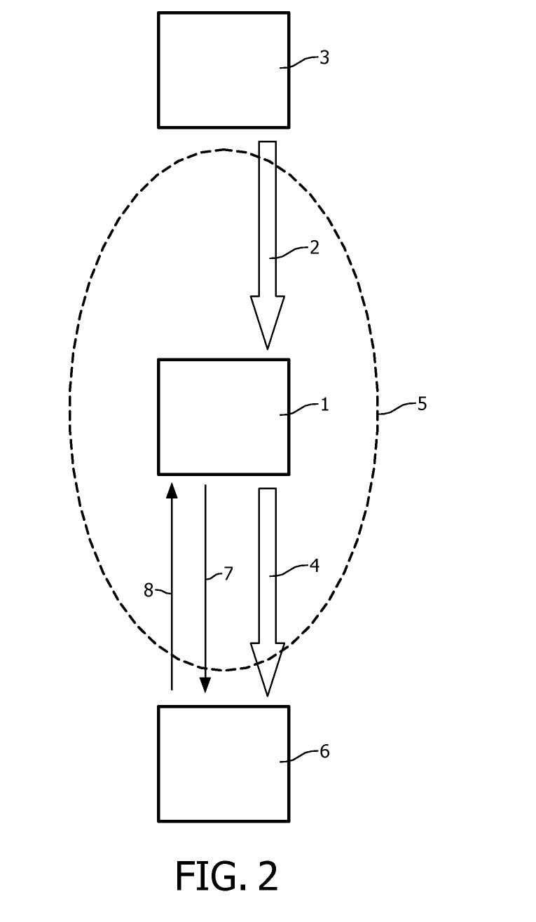

In the FIG. 2, a source device 3, an intermediate device 1 and a destination device 6 are shown, with a network 5 being present between the source device 3 and the destination device 6, whereby the intermediate device 1 forms part of this network 5.

In the FIG. 1, the network 5 may further comprise the intermediate device 1 and/or the destination device 6. In the FIG. 2, the network 5 may further comprise the source device 3 and/or the destination device 6.

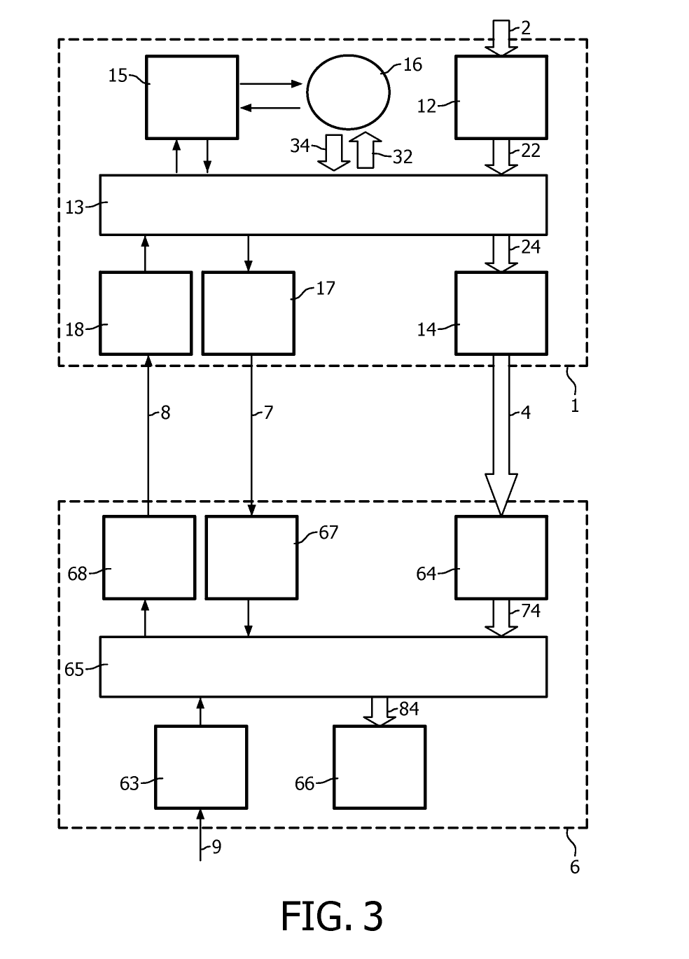

In the FIG. 3, an intermediate device 1 and a destination device 6 are shown in greater detail. The intermediate device 1 for example comprises a first receiver 12 for receiving streaming information 2 from the source device 3 and for supplying this streaming information 2 or a conversion 22 thereof to a first switching controller 13. The first switching controller 13 provides the streaming information 2 or the conversion 22 thereof in the form of an input storage signal 32 to a circular buffer 16. The circular buffer 16 provides an output storage signal 34 to the first switching controller 13, which in response provides the streaming information 4 or a conversion 24 thereof to a first transmitter 14 of the intermediate device 1. The first transmitter 14 transmits the streaming information 4 to the destination device 6. Said conversions 22, 24 may (need to) be introduced for example in case a transmission format of the streaming information 2, 4 is different from a processing format and/or a storage format.

The intermediate device 1 for example further comprises a buffer controller 15 for controlling the circular buffer 16, a second transmitter 17 for transmitting buffer data 7 to the destination device 6, and a second receiver 18 for receiving request data 8 from the destination device 6. The buffer controller 15, the second transmitter 17 and the second receiver 18 are each coupled to the first switching controller 13.

The destination device 6 for example comprises a third receiver 64 for receiving the streaming information 4 from the intermediate device 1 and for supplying this streaming information 4 or a conversion 74 thereof to a second switching controller 65. The second switching controller 65 provides the streaming information 4 or a conversion 84 thereof to an audio/video player 66. Said conversions 74, 84 may (need to) be introduced for example in case a transmission format of the streaming information 4 is different from a processing format and/or a playing format.

The destination device 6 for example further comprises a fourth receiver 67 for receiving the buffer data 7 from the intermediate device 1, a third transmitter 68 for transmitting the request data 8 to the intermediate device 1, and a fifth receiver 63 for receiving a control signal 9 from a user. The fourth receiver 67, the third transmitter 68 and the fifth receiver 63 are each coupled to the second switching controller 65.

The user, who is for example watching a live audio/video program delivered via the streaming information 2, 4, decides to jump back in time, for example ten minutes. In a prior art situation, this user had to give a fast rewind instruction, and had to pay attention all the rewinding time until a ten-minutes-back-in-time-position had been reached.

In the present situation, the user gives a ten-minutes-back-in-time-instruction, and the second switching controller 65 uses the most recently received buffer data 7 (that is transmitted for example every second or every ten seconds or every thirty seconds or every minute or otherwise relatively regularly) to convert the ten-minutes-back-in-time-instruction into the request data 8 at the hand of the buffer data 7.

As a result, the destination device 6 can express a time-shift at the hand of the buffer data 7, such as for example a time-shift in terms of the buffer data 7 and/or a time-shift as a function of the buffer data 7, and can send the request data 8 with this time-shift to the intermediate device 1. This way, the circular buffer 16 can be used more flexibly by one destination device 6, and more than one destination device 6 could use the same circular buffer 16. This is a relatively flexible environment.

The buffer data 7 may for example define a start position of the streaming information 2, 4 in the circular buffer 16 (in which case the request data 8 may define another position related to this start position) and/or an end position of the streaming information 2, 4 in the circular buffer 16 (in which case the request data 8 may define another position related to this end position) and/or a filling degree of the circular buffer 16 (in which case the request data 8 may define a certain degree or another position related to this filling degree) and/or an expected filling degree of the circular buffer 16 (in which case the request data 8 may define a certain degree or another position related to this expected filling degree) and/or a bit rate of a stream filling the circular buffer 16 (in which case the request data 8 may be based on this bit rate) etc.

The audio/video player 66 may alternatively be another player and/or may alternatively be located outside the destination device 6. The first transmitter 14/third receiver 64 on the one hand and the second transmitter 17/fourth receiver 67 on the other hand may use different wired/wireless connections and/or may use the same wired/wireless connection and may use different wired/wireless channels and/or may use the same wired/wireless channel. The second transmitter 17/fourth receiver 67 on the one hand and the second receiver 18/third transmitter 68 on the other hand may use different wired/wireless connections and/or may use the same wired/wireless connection and may use different wired/wireless channels and/or may use the same wired/wireless channel.

Inside the intermediate device 1 and inside the destination device 6, any two or more blocks may be combined/integrated into one new block, and each block may be divided into two or more sub-blocks. For example, one or more transmitters and one or more receivers may be combined into a transceiver. As long as time-shifting is not required, inside the intermediate device 1, the first switching controller 13 may interconnect the first receiver 12 and the first transmitter 14, and may tap off the streaming information 2 or the conversion 22 thereof for being stored into the circular buffer 16 via the input storage signal 32, and without using the output storage signal 34.

At first, time-shifting can only be done back in time, but as soon as time-shifted (delayed) streaming information is received, jumps in time either may go further back in time or may go back to the present, partially or fully. In case a user wants to go back in time more than possible, this is not possible and the intermediate device 1 will return the oldest streaming information that is still available.

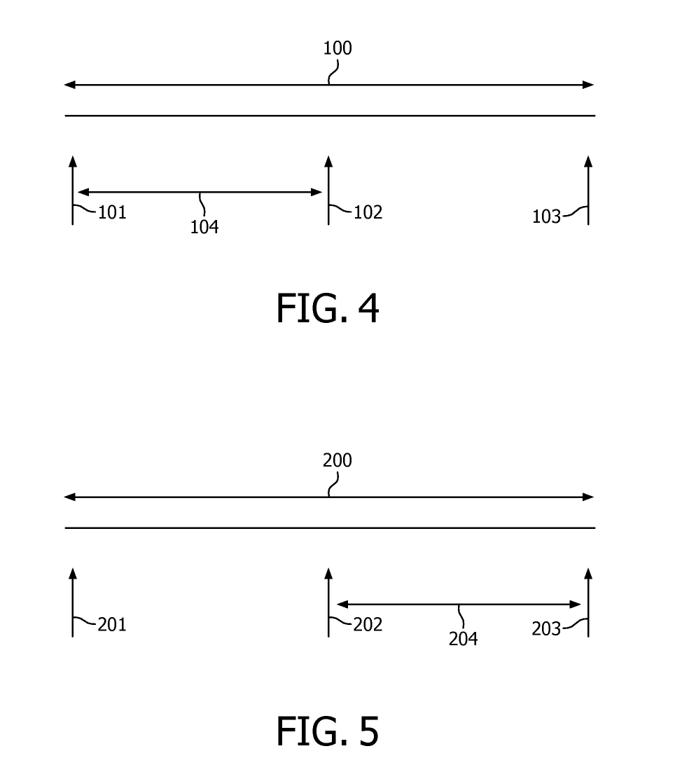

In the FIG. 4, a representation of a circular buffer from a server's view is shown. Arrow 100 defines a maximum recording time, arrow 101 defines old info, arrow 102 defines present info, arrow 103 defines a wrap around time, and arrow 104 defines a recording.

In the FIG. 5, a representation of a circular buffer from a client's view is shown. Arrow 200 defines a maximum recording time, arrow 201 defines maximum recording info, arrow 202 defines old info, arrow 203 defines present info, and arrow 204 defines a recording.

So, a buffer for time-shifting streaming information could be exposed by means of for example a http server and the time-shifted streaming information could be retrieved by for example a http client. This looks like a normal http-get from the client side but there are some differences with respect to the file size (in principal endless) and the wrap around feature of the buffer.

The buffer itself could be mapped on a virtual file. This mapping is done reversed in time with respect to the file size so that a last point in time is known instead of a first point in time. A circular buffer may be used for storing a real time content from a source device that is not capable of storing content. This circular buffer has two defined positions. A first defined position is the “now” or “present” cursor, the point on which the new real time content will be stored. A second defined position is the “old” cursor. This is the oldest content which can be used for playback. This content will be overwritten again by the real time content. A maximum recording time may be a maximum buffer size. The recording will grow in time from zero until the maximum buffer size is reached. The file exposed will have the maximum buffer size (in total, when the buffer can grow over time).

Adaptations at the intermediate device might be that for example a http head command may be used to return a maximum buffer size as a file size of the exposed file, and that for example a http head command may be used to give out a signature on which the destination device can see that it is not a normal file. If the destination device cannot recognize this special signature, the file will be regarded to be a normal file, therefore a special mime-type could be used for a signature, for example by adding the keyword circular to the end of a normal mime-type (examples: audio/wav-circular, video/mpeg2-circular etc.).

Adaptations at the destination device might be that the destination device should be able to recognize the special mime type, that the destination device should interpret the file size as “reversed” in time, that a file size max=the current time (e.g. one cannot play content which has not been stored so far), that a file size zero=oldest stored data, that the destination device should not stop asking data when already asked for max file size bytes, that the destination device should start reading at the end of file (e.g. showing the content of “now”) and that the destination device can seek in the file for “jumping” in time. To jump back/forward in time, the streaming information may have a known “average” bit rate. From this bit rate, a mapping could be made for seeking in the file. The actual point for said seeking back is based on the file position. So when jumping back ten seconds, the file position can be exactly calculated, although the file position itself does not represent T minus ten seconds. But since this all is based on averages, the returned value will be close to T minus ten seconds. Alternatively, an exact position in the file (with frame resolution) can also be known, based on the detection of frame boundaries in the stream on the input storage signal 32 and the information where the frame boundaries are in the file. This information can be used to create an exact mapping of time and position. The detection of the frame boundaries will differ per video format.

Summarizing, intermediate devices 1 such as server devices receive streaming information 2 from source devices 3 and transmit the streaming information 4 possibly in a time-shifted manner via networks 5 to destination devices 6 such as client devices in client-server-combinations. To offer the time-shifted manner, the intermediate devices 1 comprise circular buffers 16 for storing at least parts of the streaming information 2, 4. By providing the intermediate devices 1 with transmitters 17 for transmitting buffer data 7 to the destination devices 6 and with receivers 18 for receiving request data 8 from the destination devices 6, for example in accordance with a network protocol, with the request data 8 defining sizes of time-shifts expressed at the hand of the buffer data 7, the circular buffers 16 can be used more flexibly by one destination device 6 and can be used by more than one destination device 6 in a relatively flexible environment. The intermediate/destination devices 1, 6 may be universal-plug-and-play-devices and/or digital-living-network-alliance-devices and/or open-internet-protocol-television-forum-devices and/or hybrid-broadcast-broadband-television-devices.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein different parts of the different disclosed embodiments are combined into a new embodiment.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. An intermediate device for receiving streaming information from a source device and for transmitting the streaming information in a time-shifted manner via a network to a destination device, the intermediate device comprising:
a circular buffer for storing at least a part of the streaming information and for offering the time-shifted manner,
a transmitter for transmitting buffer data to the destination device, and
a receiver for receiving request data from the destination device, the request data defining a size of a time-shift expressed at the hand of the buffer data.

2. The intermediate device as defined in claim 1, the destination device being at least a part of a client device and the intermediate device being at least a part of a server device in a client-server-combination.

3. The intermediate device as defined in claim 1, the intermediate device and the destination device being at least parts of universal-plug-and-play-devices and/or of digital-living-network-alliance-devices and/or of open-internet-protocol-television-forum-devices and/or of hybrid-broadcast-broadband-television-devices.

4. The intermediate device as defined in claim 1, the buffer data and the request data being in accordance with a network protocol of the network.

5. The intermediate device as defined in claim 4, the network protocol being a hypertext transfer protocol or a real time protocol or a wireless network protocol.

6. The intermediate device as defined in claim 1, the buffer data defining a start position of the streaming information in the circular buffer and/or an end position of the streaming information in the circular buffer and/or a filling degree of the circular buffer and/or an expected filling degree of the circular buffer and/or a bit rate of a stream filling the circular buffer.

7. A destination device for receiving streaming information possibly in a time-shifted manner via a network from an intermediate device that comprises a circular buffer for storing at least a part of the streaming information originating from a source device and for offering the time-shifted manner, the destination device comprising:
a further receiver for receiving buffer data from the intermediate device, and
a transmitter for transmitting request data to the intermediate device, the request data defining a size of a time-shift expressed at the hand of the buffer data.

8. The destination device as defined in claim 7, the destination device being at least a part of a client device and the intermediate device being at least a part of a server device in a client-server-combination.

9. The destination device as defined in claim 7, the intermediate device and the destination device being at least parts of universal-plug-and-play-devices and/or of digital-living-network-alliance-devices and/or of open-internet-protocol-television-forum-devices and/or of hybrid-broadcast-broadband-television-devices.

10. The destination device as defined in claim 7, the buffer data and the request data being in accordance with a network protocol of the network.

11. The destination device as defined in claim 10, the network protocol being a hypertext transfer protocol or a real time protocol or a wireless network protocol.

12. A system for exchanging streaming information, the system comprising the intermediate device as defined in claim 1 and further comprising the source device and/or the network, or the system comprising the destination device as defined in claim 7 and further comprising the network.

13. A method for receiving streaming information from a source device and for transmitting the streaming information possibly in a time-shifted manner via a network to a destination device, the method comprising:
via a circular buffer, storing at least a part of the streaming information and offering the time-shifted manner,
via a transmitter, transmitting buffer data to the destination device, and
via a receiver, receiving request data from the destination device, the request data defining a size of a time-shift expressed at the hand of the buffer data.
